(19) United States
(12) Patent Application Publication
(10) Pub. No.: US 2005/0183815 A1
(43) Pub. Date: Aug. 25, 2005

(54) Tire ply forming apparatus and process

(76) Inventors: Toshiyuki Tanaka, Osaka (JP); Yu Hatayama, Osaka (JP)

Correspondence Address: JORDAN AND HAMBURG LLP, 122 EAST 42ND STREET, SUITE 4000, NEW YORK, NY, 10168, US

(21) Appl. No.: 10/786,805

(22) Filed: Feb. 25, 2004

(51) Int. Cl. B29D 30/38; B32B 31/00

(52) U.S. Cl. 156/264; 156/304.1; 156/406.4; 156/510; 156/906

(57) ABSTRACT

A tire ply forming apparatus includes: a roller mechanism for unwinding a narrow ribbon-shaped ply cord from a roll of the ply cord as conveying the unwound ply cord; a cutter for cutting the unwound ply cord into the strip of a length conforming to a tire width; a bonding drum on which the strips are sequentially bonded to each other along a predetermined direction and at a predetermined pitch; transfer device for transporting the strip from a cutting position to the bonding drum; controller for driving-wise controlling the bonding drum to permit the strips to be bonded to each other in a manner that the strips are overlapped with each other to form a predetermined amount of overlap at their longitudinal edges; and a pressure roller for pressing down on the overlap portion of the strips.

### BACKGROUND OF THE INVENTION

1. Field of the Invention

The present invention relates to a tire ply forming apparatus for forming a tire ply for vehicle from a narrow ribbon-shaped ply cord, and to a tire ply forming process.

2. Background Art

A tire ply for use in a green tire, such as a carcass ply, is conventionally manufactured as follows, in general. First, a plurality of fiber cords is subjected to a dipping machine to produce dipped cords. Then, the dipped cords are processed with a rubber mixture by a topping calendar machine to produce a sheet of rubber-topped cord in a large width dimension of about 1 m.

The sheet of rubber-topped cord is cut into wide ply cord sheets or ply cord, of a width conforming to a tire width. The wide ply cords thus cut are bonded to each other at their ends in a circumferential direction of a tire in a form of ribbon. The resultant band-shaped ply cord is wound into a roll which is temporarily stored. In a ply forming step, the wide ribbon-shaped ply cord is unwound from the roll so as to be conveyed. The ply cord is cut into pieces of a length required for forming individual tires (the length equivalent to a circumference of the tire). Subsequently, the resultant cord piece is stuck to a tire building drum thereby to form a ply.

However, the tire ply varies in length or width depending upon the size of a tire to be built. This dictates the need for preparing plural kinds of rolls of wide ribbon-shaped ply cords in correspondence to the different sizes or specifications of tires. For the purpose of keeping a huge stock of many kinds of rolls, a manufacturing facility is expanded in scale so as to provide a space to store the rolls. In addition, a huge number of management steps are required. That is, it is difficult to manufacture small batches of different types of tires.

As an improvement of the prior art for overcoming the above problem, there is known a process for forming a ply member as disclosed in JP-4(1992)-226742A. According to the process, plural ribbon-shaped members of a constant length are sequentially stuck to the overall peripheral surface of the tire building drum. Specifically, the ribbon-shaped members are sequentially stuck to the tire building drum as positioned to direct their opposite edges parallel to an axis of the tire building drum. On the periphery of the tire building drum, a respective pair of adjoining ribbon-shaped members are forcibly pulled to each other along a circumferential direction of the tire building drum, so as to be bonded to each other at their edge faces or in end-to-end relation. This negates the need for preparing plural kinds of ribbon-shaped members of different widths, offering a solution to the problem associated with the storage space.

However, even the above improved prior-art has the following problem. The ribbon-shaped members are bonded to each other with their ends connected in end-to-end relation. This leads to a problem that a sufficient bonding strength at the bonded portion is not ensured. In particular, a tire building procedure includes a step of inflating the ply stuck to the tire building drum. The step involves a fear that a tire having desired performances may not be built if the bonded portion is poor in the bonding strength.

In view of the foregoing, it is intended to provide a ply forming apparatus and process ensuring the sufficient bonding strength in a tire ply at joints between narrow strips (ribbon-shaped members) bonded to each other at their longitudinal edges.

### SUMMARY OF THE INVENTION

According to the invention for solving the above problem, a ply forming apparatus comprises: a feeder for unwinding a narrow ribbon-shaped ply cord from a roll of the ply cord as conveying the unwound ply cord; cutting means for cutting the unwound ply cord into a strip having a length conforming to a tire width; a bonding base on which the strips are sequentially bonded to each other along a predetermined direction and at a predetermined pitch; transfer device for transporting the strip from a cutting position to the bonding base; controller for driving-wise controlling the bonding base to permit the strips to be bonded to each other in a manner that the strips are overlapped with each other to form a predetermined amount of overlap along their longitudinal edges; and pressing device for pressing down on the overlap portion of the strips.

The ply forming apparatus has the following operating effects. First, the apparatus unwinds the narrow ribbon-shaped ply cord from the roll of the ribbon-shaped ply cord so as to convey the unwound ply cord. Subsequently, the apparatus cuts the ply cord into the strip having the length conforming to the tire width. The apparatus can cope with tires having different sizes or the like by varying the length of the strip. Thus, the apparatus is adapted for the production of small batches of tires of different types.

The strips thus cut are sequentially bonded to each other on the bonding base. The strips are sequentially bonded to each other at a predetermined pitch in a manner that the strips are overlapped with each other to form a predetermined amount of overlap at their longitudinal edges. The apparatus is provided with the pressing device for pressing down on the above overlap portion. The pressing device ensures that the overlap portion attains a sufficient bonding strength. Specifically, when the strips are sequentially bonded to each other, the strips are overlapped with each other at their longitudinal edges rather than simply connected to each other in end-to-end relation. In consequence, there is provided the ply forming apparatus which is capable of achieving the sufficient bonding strength of the ply formed by bonding the narrow strips or ribbon-shaped members to each other at their longitudinal edges.

According to a preferred embodiment of the invention, the pressing device comprises a plurality of pressure rollers arranged along the overlap portion.

The pressing operation can be quickly and effectively accomplished by virtue of the provision of the plural pressure rollers.

According to another preferred embodiment of the invention, the apparatus further comprises roller moving device for moving the plural pressure rollers along the longitudinal direction.

A more effective pressing operation can be accomplished by moving the plural pressure rollers along the longitudinal direction of the strip.

According to the invention for solving the above problem, a tire ply forming process comprises the steps of: unwinding a narrow ribbon-shaped ply cord from a roll of the ply cord as conveying the unwound ply cord; cutting the unwound ply cord into a strip having a length conforming to a tire width; transporting the strip from a cutting position to a bonding base; sequentially bonding the strips to each other along a predetermined direction and at a predetermined pitch, the strips bonded to each other as overlapped with each other to form a predetermined amount of overlap at their longitudinal edges; and pressing down on such overlap portion of the strips.

The working effects provided by the process are those mentioned supra.

### BRIEF DESCRIPTION OF THE DRAWINGS

FIG. 1 is a conceptual diagram illustrating an arrangement of a ply forming apparatus;

FIG. 2 is a diagram showing details of pressing device; and

FIG. 3 is a flow chart representing steps of forming a ply.

### DETAILED DESCRIPTION OF THE INVENTION

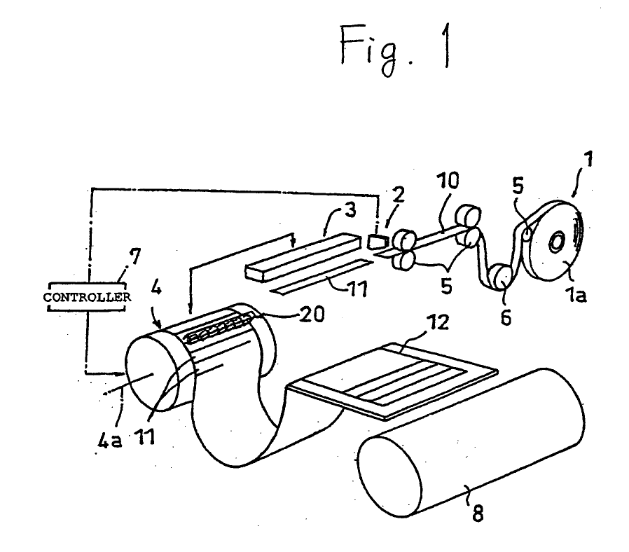

A tire ply forming apparatus according to a preferred embodiment of the invention will be described with reference to the accompanying drawings. FIG. 1 is a conceptual diagram illustrating an arrangement of the tire ply forming apparatus.

<Ply Forming Apparatus>

As shown in FIG. 1, the apparatus includes: a strip roll 1 comprising a narrow ribbon-shaped ply cord 10 wound into a roll; a cutter 2 for cutting the ply cord 10 unwound from the roll 1 into a strip 11 having a predetermined dimension; a bonding drum 4; and transfer device 3 that suction-wise attaches the strip 11 cut off by the cutter 2 and then transfers the strip onto an outer periphery surface of the bonding drum 4 (a kind of bonding base), where the bonding is to be taken place.

The narrow ribbon-shaped ply cord 10 may be produced by the known method, as in a same manner with the method for producing a wide ribbon-shaped ply cord. That is, the ply cord 10 is produced by applying rubber coating on a plurality of fiber cords. The ribbon-shaped ply cord 10 is small in width such as to provide for the production of small batches of various types of tires. The ribbon-shaped ply cord 10 produced in the aforementioned manner is temporarily wound into the roll 1 before committed to storage. The ribbon-shaped ply cord 10 is unwound from the roll 1 when a ply forming process is carried out. The apparatus is further provided with a feeder for unwindingly conveying the ply cord.

The a feeder may have the known arrangement which includes a plurality of roller mechanisms 5 disposed along a conveyance passage of the ribbon-shaped ply cord 10. The a feeder further includes a festoon 6 for speed control. The festoon is free to move up or down. The roll 1 is connected with an unillustrated electric motor at its center of rotation 1a. The cutter 2 operates to cut the ribbon-shaped ply cord 10 into the strip 11. The cutter is adapted to vary the longitudinal length of the strip 11 to be cut. That is, the ribbon-shaped ply cord 10 is cut into a length conforming to a tire width. It is noted that “the length conforming to the tire width” does not mean a length equal to the tire width.

The transfer device 3 includes a vacuum chuck mechanism (not shown) formed with a chuck face on a side facing the strip 11. The vacuum chuck mechanism employs a known mechanism for suction-wise attaching the strip 11 to a predetermined place of the chuck face.

Although not shown in the figure, the transfer device 3 is provided with a mechanism for moving up or down the transfer device 3 so as to attach the strip 11, and a mechanism for transeversely moving the transfer device 3 as to transport the attached strip 11 from a cutting position to the bonding drum 4. The bonding drum 4 is driven into rotation about a center of rotation thereof 4a by means of an unillustrated electric motor.

Controller 7 essentially comprises a computer and a computer program. The controller 7 controls the operations of the transfer device 3 and the bonding drum 4.

On the bonding drum 4, the strips 11 supplied by the transfer device 3 are sequentially bonded to each other in a manner that the strips are overlapped with each other to form a predetermined amount of overlap at their longitudinal edges. The bonding drum 4 is provided with pressing device 20 for pressing down on the overlap portion. A ply sheet 12 is formed by sequentially bonding the strips 11 to each other. The ply sheet 12 is conveyed by a conveyance mechanism so as to be fed to a tire building drum 8. Similarly to the conveyance of the ply cord 10, the conveyance mechanism may adopt a known structure.

When a length of ply sheet 12 constituting a tire body is stuck onto the tire building drum 8, the ply sheet 12 is cut off. The operation of sticking the ply sheet 12 onto the tire building drum 8 may be carried out the same way as in the conventional method. Subsequently, a predetermined procedure (the explanation thereof is omitted) is taken to manufacture a green tire.

<Construction of Pressing Device>

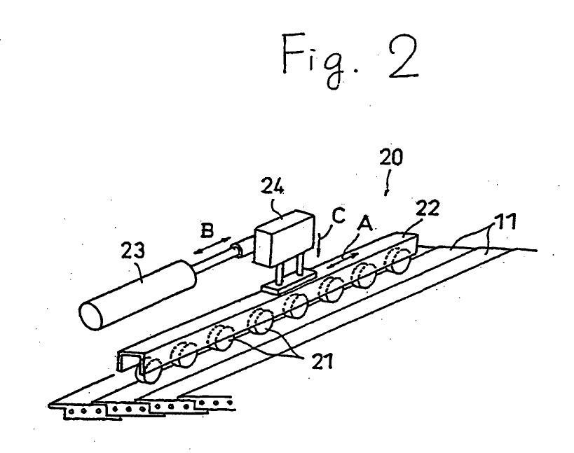

FIG. 2 is a diagram showing details of the pressing device. The pressing device 20 includes a plurality of pressure rollers 21 arranged along the longitudinal overlap portion of the edges of the strips. The pressing device further includes a guide 22 that also has a function to support the pressure rollers 21. The guide 22 has an inverse U-shape in cross section such as to provide a widthwise support for the pressure rollers 21. Furthermore, the guide is adapted to move along the longitudinal direction (the direction of Arrow A). As associated with the guide, the plural pressure rollers 21 are also allowed to move along the direction of Arrow A. Thus, the pressure rollers can uniformly press down on the whole area of the overlap portion, thereby making the bond between the strips 11 stronger. After pressed, the bonded strips form a flat ply sheet free from surface irregularities.

A first actuator cylinder 23 and a second actuator cylinder 24 are provided for driving the pressing device 20. The second actuator cylinder 24 and the guide 22 may be moved along the direction of Arrow “A” by driving the first actuator cylinder 23 (as indicated by Arrow “B”). The second actuator cylinder 24 may be driven to push down the guide 22 (the direction of Arrow “C”) thereby effectively applying the pressing force via the pressure rollers 21.

<Ply Forming Process>

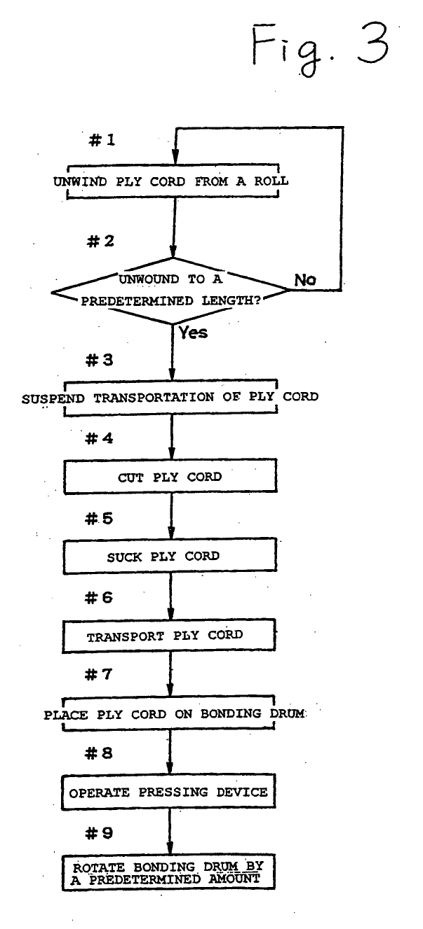

Next, a procedure for forming the ply will be described with reference to a flow chart of FIG. 3.

First, the ribbon-shaped ply cord is sequentially unwound from the strip roll 1 (#1). Determination is made as to whether a predetermined length of ply cord 10 from the cutting position of the cutter 2 is fed out or not (#2). The control may be performed based on a pulse signal outputted from an encoder directly or indirectly coupled or connected with a roller mechanism 5. The predetermined length of the ply cord is decided based on a tire size or specifications of the tire. When the predetermined length of ply cord is fed out, the conveyance of the ply cord is temporarily suspended (#3) Then, the cutter 2 is actuated to cut the ribbon-shaped ply cord 10 into the strip 11 (#4).

Next, the transfer device 3 is actuated for suction-wise attaching the strip 11 to the chuck face thereof (#5). The transfer device 3 is driven to transport the strip 11 from the cutting position to the bonding drum 4 (#6). Subsequently, the strip 11 is released from the attached state so as to be placed on the bonding drum 4 (#7). The strip 11 is placed on the bonding drum in a manner that a longitudinal edge of the newly placed strip 11 is overlapped with that of the preceding strip 11. Meantime, the transfer device 3 is returned to its initial position as to suction-wise attach the succeeding strip 11.

Next, the pressing device 20 is actuated to press down on the overlap portion (#8). First, the second actuator cylinder 24 is driven to apply the pressing force to the pressure rollers 21. In this state, the first actuator cylinder 23 is driven. This brings the guide 22 into movement along the longitudinal direction. Accompanying with the movement, the pressure rollers 21 are moved as to roll along the longitudinal direction. As a result, the pressure is uniformly applied to the overlap portion so as to strengthen the bonded joint.

At completion of the pressing operation, the bonding drum 4 is rotated by a predetermined amount (angle) (#9). This permits the drum to receive the next strip 11 to be bonded. Subsequently, the same procedure may be repeated.

### Other Preferred Embodiments

According to the embodiment of the invention, various modifications may be made to the elements constituting the tire ply forming apparatus. For instance, the bonding base is exemplified by the bonding drum but is not limited to this. Alternatively, a belt conveyor may be employed for bonding purpose. In this case, the strips are bonded to each other on a flat surface. Furthermore, the pressing device may employ a member having a flat pressing face in place of the roller. The amount of overlap of the strips may be defined properly in accordance with specific condition or requirement.

FIG. 1
CONTROLLER

FIG. 3
#1 UNWIND PLY CORD FROM A ROLL
#2 UNWOUND TO A PREDETERMINED LENGTH?
#3 SUSPEND TRANSPORTATION OF PLY CORD
#4 CUT PLY CORD
#5 SUCK PLY CORD
#6 TRANSPORT PLY CORD
#7 PLACE PLY CORD ON BONDING DRUM
#8 OPERATE PRESSING DEVICE
#9 ROTATE BONDING DRUM BY A PREDETERMINED AMOUNT

1. A ply forming apparatus comprising:
a feeder for unwinding a narrow ribbon-shaped ply cord from a roll of the ply cord as conveying the unwound ply cord;
cutter for cutting said unwound ply cord into a strip of a length substantially conforming to a tire width;
a bonding base on which said strips are sequentially bonded to each other along a predetermined direction and at a predetermined pitch;
transfer device for transporting said strip from a cutting position to the bonding base;
controller for driving-wise controlling said bonding base to permit said strips to be bonded to each other in a manner that the strips are overlapped with each other to form a predetermined amount of overlap along their longitudinal edges; and
pressing device for pressing down on such overlap portion of said strips.

2. A ply forming apparatus as claimed in claim 1, wherein said pressing device comprises a plurality of pressure rollers arranged along said overlap portion.

3. A ply forming apparatus as claimed in claim 2, further comprising roller moving device for moving said plural pressure rollers along the longitudinal direction.

4. A ply forming process comprising the steps of:
unwinding a narrow ribbon-shaped ply cord from a roll of the ply cord as conveying the unwound ply cord;
cutting said unwound ply cord into a strip having a length substantially conforming to a tire width;
transporting said strip from a cutting position to a bonding base;
sequentially bonding said strips along a predetermined direction and at a predetermined pitch, said strips bonded to each other as overlapped with each other to form a predetermined amount of overlap along their longitudinal edges; and
pressing down on such overlap portion of said strips.
